(19) United States
(12) Patent Application Publication
(10) Pub. No.: US 2009/0177616 A1
(43) Pub. Date: Jul. 9, 2009

(54) HARDWARE SECURITY UNIT AND MULTIPLE-VALUED LOGIC OPERATIONAL METHOD THEREOF

(75) Inventors: Xizhe Li, Beijing (CN); Hongping Tian, Beijing (CN); Wei Xie, Beijing (CN); Yun Gu, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignees: BEIJING LENOVO SOFTWARE LTD., Beijing (CN); LENOVO (BEIJING) LIMITED, Beijing (CN)

(21) Appl. No.: 12/342,976

(22) Filed: Dec. 23, 2008

(30) Foreign Application Priority Data
Jan. 9, 2008 (CN) 200810055821.X

(51) Int. Cl. G06F 17/00

(52) U.S. Cl. 706/54

(57) ABSTRACT

A hardware security unit and a multiple-valued logic operational method thereof are provided, which comprises at least a first and a second multiple-valued logic calculation units, an operational unit, a judgment unit and an execution unit. The first multiple-valued logic calculation unit and the second multiple-valued logic calculation unit are connected to the operational unit, each of the multiple-valued logic calculation units comprises at least three registers for describing expected logical state, current logical state and a multiple-valued logic operator of a specific entity of the hardware security unit. The operational unit calculates the expected logical states of the first and second multiple-valued logic calculation units and the current logical states of the first and second multiple-valued logic calculation units, respectively, by using the multiple-valued logic operator in the third register of the second multiple-valued logic calculation unit, so as to obtain expected and current logic operation results. The judgment unit is connected to the operational unit, for judging whether the current logic operation result has reached the expected logic operation result. The execution unit is connected to the judgment unit, for executing a corresponding operation based on the judgment result by the judgment unit. When it is determined that the current logic operation result equals to the expect logic operation result, the hardware security unit performs a corresponding operation. Therefore, a hardware security unit and a multiple-valued logic operational method thereof are provided for solving the problems arise upon providing services to the overall trust chain based on a binary logic judgment.

### BACKGROUND OF THE INVENTION

1. Field of Invention

The present invention relates to a hardware security system, in particular to a hardware security unit and a multiple-valued logic operational method thereof.

2. Description of Prior Art

In specifications of the existing TCG (Trusted Computing Group) and international security chip, it is defined that a security chip, i.e., a hardware security unit, shall provide services for entire trust chain based on a binary logic (True or False) judgment.

In the case of binary logic, three major functions are provided by a security chip, including:
1. Platform measurement, for providing the comparison of measurement result and restriction on the use of entities within the chip, such as a key, when the measurement result is True;
2. Key management, for performing generation, loading, use and destroy of a key when the results of platform measurement and of authorization are both True; and
3. Cryptography services, for providing cryptography related services when the results of platform measurement and of authorization are both True.

However, the existing binary logic has constraints on the use of the security chip, which are described in the following.

1. In a virtual environment, more than one Operating System (OSs) may be run simultaneously by a user. Security level is differentiated between OSs. OS with a higher security level, which can be dedicated to only specific purposes such as financing, have requirements on a trust chain of high reliability and screening of all irrelevant operations. This can be supported by the existing design of the security chip. For OS with a lower security level, such as OSs dedicated to internet surfing and games, however, frequent installation and/or uninstallation of unknown software is required. It will result in frequent changes in the result of the platform measurement. According to the existing design of the security chip, it is difficult for these OSs to receive the key management and the cryptography services provided by the security chip. Users using OSs with a lower security level also have certain security requirements which should not be ignored. A part of services should be opened without affecting the security and trustability of the security chip and the trust chain.

In the existing patented solutions, the basic idea is to provide hierarchical services for VTs using virtual security chips or multiple-strategy security chips. While the idea is technically feasible, the cost of implementation is relatively high since space for multiple Owners or strategy tables is required, which results in higher requirements on the memory capacity and the execution capability of the security chip.

2. In the case of a conventional single OS, a user can perform encryption using some keys bound to values of the platform measurements. Operations leading to changes in the result of the platform measurement may be performed, such as reinstallation of the OS, update and replacement of hardware and software and update and deletion of some important application programs. When the changes in the result of the platform measurement occur in the security chip, the use of the original Key is prohibited by the existing design of the security chip, which can cause inconvenience to users. Certain Keys should be opened; the usage logic of the Keys should be selected by users; and relevant parts of services should be provided without affecting the security and trustability of the security chip and the trust chain.

3. The key transfer between TPM/TCMs is defined in the existing security specifications of TCG and national standards. In fact, the flow of the user-authorized key transfer between trusted environments is defined, since the PC environment before transfer is trusted and the process of transfer has to be authorized by the Owner. The possibility of transferring a key to a device with no input and likely with a lower security level is restricted substantially by the binary logic condition of environment=True and Owner=True. It is difficult for the security chip to ensure the trustability of some usage environments, such as mobile payment chips in mobile phones, USBKeys and USBTokens, while such responsibility is indispensably involved in the relevant applications of mobile payment and online bank. It is thus desirable that the security chip can store some bound private data and Keys with lower security requirement in the chip of a mobile phone, USBKey or USBToken, in order to support the cooperation between the security chip and online bank and mobile phone payment using USBKey and USBToken.

### SUMMARY OF THE INVENTION

The object of the present invention is to provide a hardware security unit and a multiple-valued logic operational method thereof, which can solve the problem in providing services to a entire trust chain based on binary logic judgment in the prior art.

A hardware security unit comprising at least a first multiple-valued logic calculation unit, a second multiple-valued logic calculation unit and an operational unit, the first multiple-valued logic calculation unit and the second multiple-valued logic calculation unit being connected to the operational unit, respectively, each of the multiple-valued logic calculation units comprises at least three registers:
a first register for describing expected logical state of a specific entity of the hardware security unit,
a second register for describing current logical state of a specific entity of the hardware security unit, and
a third register for describing a multiple-valued logic operator between specific entities of the hardware security unit;

the operational unit is configured to apply calculation to the first expected logical state of the first multiple-valued logic calculation unit and the second expected logical state of the second multiple-valued logic calculation unit to obtain an expected logic operation result, and to apply calculation to the first current logical state of the first multiple-valued logic calculation unit and the second current logical state of the second multiple-valued logic calculation unit obtain a current logic operation result, by using the multiple-valued logic operator in the third register of the second multiple-valued logic calculation unit.

Preferably, the specific entities of the hardware security unit are any two of owner's password Owner, platform information PCR, storage root key SRK, key Key, private password and protected data.

Preferably, the hardware security unit further comprises a setting unit connected to at least one of the first and second multiple-valued logic calculation units, for setting the expected logical state and the multiple-valued logic operator of the connected multiple-valued logic calculation unit

Preferably, the setting unit comprises a setting unit for user and a setting unit for hardware security unit, the setting unit for hardware security unit being used to preset the expected logical states and the multiple-valued logic operator for the Owner, the PCR and the SRK.

Preferably, the hardware security unit further comprises a checking unit connected to both of the first and second multiple-valued logic calculation units, for checking the first and second current logical states in the second registers of the first and second multiple-valued logic calculation units.

Preferably, the hardware security unit further comprises a maintenance unit connected to both of the first and second multiple-valued logic calculation units, for maintaining the first and second current logical states in the second registers of the first and second multiple-valued logic calculation units.

Preferably, the hardware security unit further comprises an updating unit connected to both of the first and second multiple-valued logic calculation units, for updating the first and second current logical states in the second registers of the first and second multiple-valued logic calculation units.

Preferably, the hardware security unit further comprises a counting unit connected to both of the first and second multiple-valued logic calculation units, for counting any used multiple-valued logic calculation units, wherein the operational unit performs logic operations based on the multiple-valued logic operators in the third registers of the multiple-valued logic calculation units counted by the counting unit.

Preferably, the hardware security unit further comprises a judgment unit connected to the operational unit, for judging whether the current logic operation result has reached the expected logic operation result.

Preferably, the hardware security unit further comprises an execution unit connected to the judgment unit, for executing a corresponding operation based on the judgment result by the judgment unit.

A multiple-valued logic operational method for the above hardware security unit, the method comprises:

applying, by the operational unit, calculation to the first expected logical state of the first multiple-valued logic calculation unit and the second expected logical state of the second multiple-valued logic calculation unit to obtain an expected logic operation result, using the multiple-valued logic operator in the third register of the second multiple-valued logic calculation unit; and

applying, by the operational unit, calculation to the first current logical state of the first multiple-valued logic calculation unit and the second current logical state of the second multiple-valued logic calculation unit obtain a current logic operation result, using said multiple-valued logic operator.

Preferably, the method further comprises, before the step of applying calculation, a setting step of setting the expected logical state and the multiple-valued logic operator of at least one of the first and second multiple-valued logic calculation units in advance.

Preferably, the method further comprises, before the step of applying calculation, a counting step of counting any used multiple-valued logic calculation units, wherein the operational unit performs logic operations based on the multiple-valued logic operators of the multiple-valued logic calculation units counted by the counting unit.

Preferably, the method further comprises, after obtaining the expected and the current logic operation results, a judgment step of judging whether the current logic operation result has reached the expected logic operation result.

Compared with the prior art described above, the hardware security unit according the embodiments of the present invention comprises at least a first and a second multiple-valued logic calculation units, an operational unit, a judgment unit and an execution unit. The first multiple-valued logic calculation unit and the second multiple-valued logic calculation unit are connected to the operational unit, each of the multiple-valued logic calculation units comprises at least three registers for describing expected logical state, current logical state and a multiple-valued logic operator of a specific entity of the hardware security unit. The operational unit calculates the expected logical states of the first and second multiple-valued logic calculation units and the current logical states of the first and second multiple-valued logic calculation units, respectively, by using the multiple-valued logic operator in the third register of the second multiple-valued logic calculation unit, so as to obtain expected and current logic operation results. The judgment unit is connected to the operational unit, for judging whether the current logic operation result has reached the expected logic operation result. The execution unit is connected to the judgment unit, for executing a corresponding operation based on the judgment result by the judgment unit.

With the foregoing technical solutions of the present invention, the following advantages can be achieved: 1) the security chip is no longer limited to binary logic operations, instead, operations and processing can be performed based on multiple-valued logic; and 2) user requirements of different security levels can be satisfied by resources of corresponding security levels by dividing the security levels using multiple-valued logic. More flexibility in user operation can be provided and the user experience can be improved.

### BRIEF DESCRIPTION OF THE DRAWINGS

FIG. 1 is a block diagram of a hardware security unit according to the first embodiment of the present invention; and

FIG. 2 is a block diagram of a hardware security unit according to the second embodiment of the present invention.

### DETAILED DESCRIPTION OF PREFERRED EMBODIMENTS

A hardware security unit and a multiple-valued logic operational method thereof are provided to solve the problems arise when providing services to an overall trust chain based on binary logic judgment in the prior art.

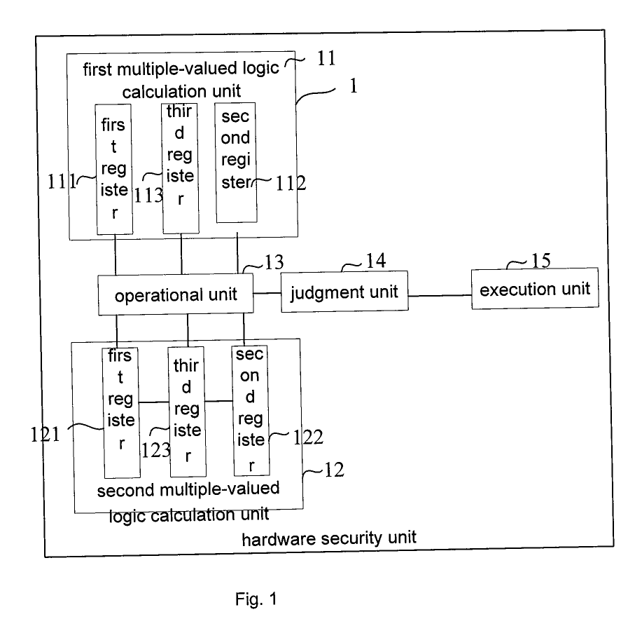

Now referring to FIG. 1, which is a block diagram of a hardware security unit according to the first embodiment of the present invention.

The hardware security unit 1 according to the first embodiment of the present invention comprises two multiple-valued logic calculation units, i.e., a first multiple-valued logic calculation unit 11 and a second multiple-valued logic calculation unit 12, an operational unit 13, a judgment unit 14 and an execution unit 15.

The first multiple-valued logic calculation unit 11 and the second multiple-valued logic calculation unit 12 each comprise three registers.

The first register 111 of the first multiple-valued logic calculation unit describes the expected logical state of a specific functional entity corresponding to the first multiple-valued logic calculation unit 11.

A second register 112 of the first multiple-valued logic calculation unit describes the current logical state of the specific functional entity corresponding to the first multiple-valued logic calculation unit 11.

A third register 113 of the first multiple-valued logic calculation unit describes a multiple-valued logic operator.

A first register 121 of the second multiple-valued logic calculation unit describes the expected logical state of a specific functional entity corresponding to the second multiple-valued logic calculation unit 12.

A second register 122 of the second multiple-valued logic calculation unit describes the current logical state of the specific functional entity corresponding to the second multiple-valued logic calculation unit 12.

A third register 123 of the second multiple-valued logic calculation unit describes a multiple-valued logic operator between the specific functional entity corresponding to the first multiple-valued logic calculation unit 11 and the specific functional entity corresponding to the second multiple-valued logic calculation unit 12.

The operational unit 13 invokes the multiple-valued logic operator in the third register 123 of the second multiple-valued logic calculation unit, and calculates the expected logical states of the first register 121 of the second multiple-valued logic calculation unit and the first register 111 of the first multiple-valued logic calculation unit, as well as the current logical states of the second register 122 of the second multiple-valued logic calculation unit and the second register 112 of the first multiple-valued logic calculation unit, based on the multiple-valued logic operator, in order to obtain an expected logic operation result and a current logic operation result, respectively.

The judgment unit 14 judges whether the current logic operation result equals to the expected logic operation result.

The execution unit 15 executes a corresponding operation based on the judgment result made by the judgment unit 14.

The hardware security unit further comprises a counting unit (not shown) connected to both of the first multiple-valued logic calculation unit 11 and the second multiple-valued logic calculation unit 12, for counting any used multiple-valued logic calculation units.

The operational unit 13 performs logic operations based on the multiple-valued logic operator in the third registers of the multiple-valued logic calculation units counted by the counting unit.

The first multiple-valued logic calculation unit 11 and the second multiple-valued logic calculation unit 12 used by the counting unit perform logic operations based on the multiple-valued operator described in the third register 123 of the second multiple-valued logic calculation unit.

The first multiple-valued logic calculation unit 11 can be any one of Owner (owner's password), PCR (platform information), SRK (storage root key), Key (key), private password and protected data.

The second multiple-valued logic calculation unit 12 can be any one of Owner, PCR, SRK, Key, private password and protected data which is different from the first multiple-valued logic calculation unit.

In general, the first multiple-valued logic calculation unit 11 has a higher security level than the second multiple-valued logic calculation unit 12, that is, the specific functional entity corresponding to the second multiple-valued logic calculation unit 12 is located behind the specific functional entity corresponding to the first multiple-valued logic calculation unit 11. In other words, when the specific functional entity corresponding to the first multiple-valued logic calculation unit 11 is Owner, the specific functional entity corresponding to the second multiple-valued logic calculation unit 12 can be any one behind Owner: the PCR, the SRK, the Key, the private password and the protected data.

When the specific functional entity corresponding to the first multiple-valued logic calculation unit 11 is the PCR, the specific functional entity corresponding to the second multiple-valued logic calculation unit 12 can be any one behind the PCR: the SRK, the Key, the private password and the protected data.

The hardware security unit 1 further comprises a checking unit (not shown) connected to both of the first multiple-valued logic calculation unit 11 and the second multiple-valued logic calculation unit 12, for checking the current logical states in the second registers 112, 122 of the first multiple-valued logic calculation unit and the second register of the second multiple-valued logic calculation unit.

The hardware security unit 1 further comprises a maintenance unit connected to both of the first multiple-valued logic calculation unit 11 and the second multiple-valued logic calculation unit 12, for maintaining the current logical states in the second registers 112, 122 of the first multiple-valued logic calculation unit and the second register of the second multiple-valued logic calculation unit.

The hardware security unit 1 further comprises an updating unit connected to both of the first and the second multiple-valued logic calculation unit, for updating the current logical states in the second register s 112, 122 of the first multiple-valued logic calculation unit and the second register of the second multiple-valued logic calculation unit.

The hardware security unit according to the present embodiment comprises at least the first multiple-valued logic calculation unit 11, the second multiple-valued logic calculation unit 12, the operational unit 13, the judgment unit 14 and the execution unit 15. Each of the multiple-valued logic calculation units comprises at least three registers which describe expected logical state, current logical state and a multiple-valued logic operator, respectively. When the hardware security unit 1 executes a command, the operational unit 13 invokes the multiple-valued logic operator in the third register 123 of the second multiple-valued logic calculation unit, and calculates the expected logical states and the current logical states of the second multiple-valued logic calculation unit 12 and the first multiple-valued logic calculation unit 11, based on the multiple-valued logic operator, in order to obtain an expected logic operation result and a current logic operation result, respectively. The judgment unit 14 decides whether the current logic operation result equals to he expected logic operation result or not. The execution unit 15 executes a corresponding operation when the current logic operation result equals to the expected logic operation result.

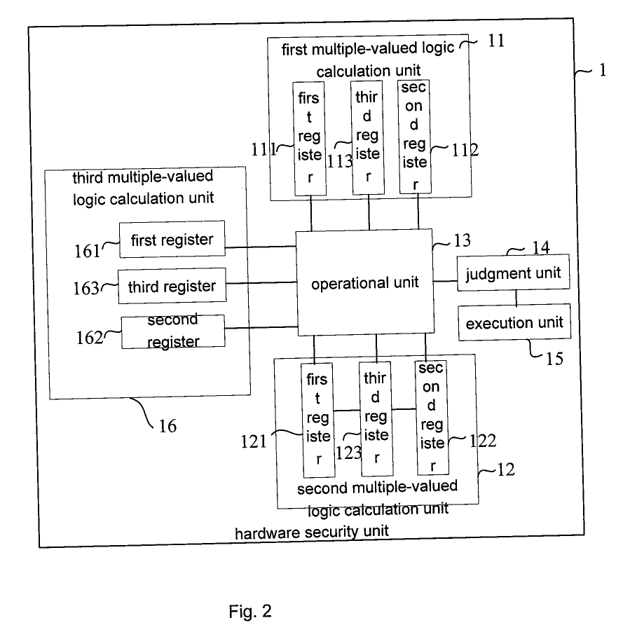

Now referring to FIG. 2, which is a block diagram of a hardware security unit according to the second embodiment of the present invention.

The hardware security unit 1 according to the second embodiment of the present invention further comprises, in addition to the components of the first embodiment, a third multiple-valued logic calculation unit 16.

Therefore, the hardware security unit 1 according to the second embodiment of the present invention uses three multiple-valued logic calculation units: the first multiple-valued logic calculation unit 11, the second multiple-valued logic calculation unit 12 and the third multiple-valued logic calculation unit 16.

The first multiple-valued logic calculation unit 11, the second multiple-valued logic calculation unit 12 and the third multiple-valued logic calculation unit 16 each comprises three registers.

The first register 111 of the first multiple-valued logic calculation unit describes the expected logical state of a specific functional entity corresponding to the first multiple-valued logic calculation unit 11.

The second register 112 of the first multiple-valued logic calculation unit describes the current logical state of a specific functional entity corresponding to the first multiple-valued logic calculation unit 11.

The third register 113 of the first multiple-valued logic calculation unit describes a multiple-valued logic operator which is a null.

The first register 121 of the second multiple-valued logic calculation unit describes the expected logical state of a specific functional entity corresponding to the second multiple-valued logic calculation unit 12.

The second register 122 of the second multiple-valued logic calculation unit describes the current logical state of a specific functional entity corresponding to the second multiple-valued logic calculation unit 12.

The third register 123 of the second multiple-valued logic calculation unit 123 describes a multiple-valued logic operator between the specific functional entity corresponding to the first multiple-valued logic calculation unit 11 and the specific functional entity corresponding to the second multiple-valued logic calculation unit 12.

The first register 161 of the third multiple-valued logic calculation unit describes the expected logical state of a specific functional entity corresponding to the third multiple-valued logic calculation unit 16.

The second register 162 of the third multiple-valued logic calculation unit describes the current logical state of a specific functional entity corresponding to the third multiple-valued logic calculation unit 16.

The third register of the third multiple-valued logic calculation unit 163 describes a multiple-valued logic operator between the specific functional entity corresponding to the second multiple-valued logic calculation unit 12 and the specific functional entity corresponding to the third multiple-valued logic calculation unit 16.

The specific functional entity corresponding to the first multiple-valued logic calculation unit 11 can be any one of Owner, PCR, SRK, Key, private password and protected data.

The specific functional entity corresponding to the second multiple-valued logic calculation unit 12 can be any one of Owner, PCR, SRK, Key, private password and protected data which is different from the specific functional entity corresponding to the first multiple-valued logic calculation unit 11.

The specific functional entity corresponding to the third multiple-valued logic calculation unit 16 can be any one of Owner, PCR, SRK, Key, private password and protected data which is different from both the specific functional entity corresponding to the first multiple-valued logic calculation unit 11 and the specific functional entity corresponding to the second multiple-valued logic calculation unit 12.

The operational unit 13 invokes the multiple-valued logic operator in the third register 123 of the second multiple-valued logic calculation unit, and calculates the expected logical states of the first register 121 of the second multiple-valued logic calculation unit and the first register 111 of the first multiple-valued logic calculation unit, as well as the current logical states of the second register 122 of the second multiple-valued logic calculation unit and the second register 112 of the first multiple-valued logic calculation unit, based on the multiple-valued logic operator, in order to obtain an expected logic operation result and a current logic operation result, respectively. Further, the operational unit 13 performs an operation between the expected logic operation result and the expected logic state of the first register 161 of the third multiple-valued logic calculation unit, based on the operational relationship corresponding to the logic operator in the third register 163 of the third multiple-valued logic calculation unit, in order to obtain a final expected logic operation result. Furthermore, the operational unit 13 performs an operation between the current logic operation result and the current logic state of the second register 162 of the third multiple-valued logic calculation unit, based on the operational relationship corresponding to the logic operator in the third register 163 of the third multiple-valued logic calculation unit, in order to obtain a final current logic operation result. The judgment unit 14 then judges whether the current logic operation result equals to the expected logic operation result or not. The execution unit 15 executes a corresponding operation when the current logic operation result equals to the desired logic operation result.

The hardware security unit 1 counts any used multiple-valued logic calculation unit, and performs logic operations based on the multiple-valued logic operators in the third registers of the multiple-valued logic calculation units.

Each of functional entities within the hardware security unit 1 can be considered as a multiple-valued logic calculation unit which can be any one of Owner, PCR, aSRK, Key, private password and protected data.

The hardware security unit 1 according to the present embodiment may comprise more than three multiple-valued logic calculation units, to each of which the corresponding functional entity can be any one of Owner, PCR, SRK, Key, private password and protected data.

The hardware security unit 1 further comprises a setting unit connected to both the first multiple-valued logic calculation unit 11 and the second multiple-valued logic calculation unit 12, for setting the expected logical states and the multiple-valued logic operators.

The setting unit of the hardware security unit presets the expected logical states and the multiple-valued logic operators of the Owner, the PCR or the SRK.

When certain multiple-valued logic calculation unit with a higher security level requirement is generated, such as Owner, SRK or a specific PCR, the highest value must be assigned for the logical state and operator by the setting unit, while the logical states and the operators of the remaining multiple-valued logic calculation units can be determined by the setting unit in accordance with a user' selection.

The hardware security unit 1 further comprises a checking unit (not shown) connected to all of the first multiple-valued logic calculation unit 11, the second multiple-valued logic calculation unit 12 and the third multiple-valued logic calculation unit 16, for checking the current logical states in the second register 112 of the first multiple-valued logic calculation unit, the second register 122 of the second multiple-valued logic calculation unit and the second register 162 of the third multiple-valued logic calculation unit.

The hardware security unit 1 further comprises a maintenance unit (not shown) connected to all of the first multiple-valued logic calculation unit 11, the second multiple-valued logic calculation unit 12 and the third multiple-valued logic calculation unit 16, for maintaining the current logical states in the second register 112 of the first multiple-valued logic calculation unit, the second register 122 of the second multiple-valued logic calculation unit and the second register 162 of third multiple-valued logic calculation unit.

The hardware security unit 1 further comprises an updating unit (not shown) connected to all of the first multiple-valued logic calculation unit 11, the second multiple-valued logic calculation unit 12 and the third multiple-valued logic calculation unit 16, for updating the current logical states in the second register 112 of the first multiple-valued logic calculation unit, the second register 122 of the second multiple-valued logic calculation unit and the second register 162 of third multiple-valued logic calculation unit.

The hardware security unit 1 further comprises a counting unit (not shown) connected to all of the second multiple-valued logic calculation units, for counting any used multiple-valued logic calculation unit.

The operational unit 13 performs logic operations based on the multiple-valued logic operator in the third register of the multiple-valued logic calculation unit counted by the counting unit.

The first multiple-valued logic calculation unit 11, the second multiple-valued logic calculation unit 12 and third multiple-valued logic calculation unit 16 used by the counting unit calculate a logic operation result between the first multiple-valued logic calculation unit 11 and the second multiple-valued logic calculation unit 12 based on the multiple-valued operator described in the third register 123 of the second multiple-valued logic calculation unit. A final logic operation result between the logic operation result and the third multiple-valued logic calculation unit 16 is then calculated using the multiple-valued logic operator described in the third register 163 of third multiple-valued logic calculation unit.

The logic operation by the operational unit 13 comprises: a multiple-valued logic operation between the multiple-valued logic calculation units in accordance with a defined operation mode; a comparison between the desired logic operation result and the current logic operation result, the comparison being performed by executing the command; and a notification to the hardware security unit 1 for providing corresponding services to the external.

Next, a description is given taking a triple-valued logic as an example of multiple-valued logic.

The triple-valued logic comprises TRUE (referred briefly to as T), FALSE (referred briefly to as F) and UNKNOWN (referred briefly to as U).

For the hardware security unit 1, T represents being trusted, F being non-trusted and U being unknown.

Several possible multiple-valued operations can be enumerated as follows.

Operation of “AND”:

| | | | |
|---|---|---|---|
| AND | TRUE | FALSE | UNKNOWN |
| TRUE | TRUE | FALSE | UNKNOWN |
| FALSE | FALSE | FALSE | FALSE |
| UNKNOWN | UNKNOWN | FALSE | UNKNOWN |

Operation of “OR”:

| | | | |
|---|---|---|---|
| OR | TRUE | FALSE | UNKNOWN |
| TRUE | TRUE | TRUE | TRUE |
| FALSE | TRUE | FALSE | UNKNOWN |
| UNKNOWN | TRUE | UNKNOWN | UNKNOWN |

Operation of “NOT”:

| | | |
|---|---|---|
| TRUE | FALSE | UNKNOWN |
| FALSE | TRUE | UNKNOWN |

Operation of “IS”:

| | | | |
|---|---|---|---|
| IS | TRUE | FALSE | UNKNOWN |
| TRUE | TRUE | FALSE | FALSE |
| FALSE | FALSE | TRUE | FALSE |
| UNKNOWN | FALSE | FALSE | TRUE |

The executing process of the conventional hardware security unit can be described as follows.

The corresponding command can be executed if the owner's password inputted by the Owner, the storage root key inputted by the SRK, the platform information inputted by the PCR or the key inputted by the Key is correct.

In the conventional hardware security unit, if the platform measurement PCR is changed, the hardware security unit becomes unavailable and thus the corresponding command can not be executed due to the incorrect platform information inputted by the PCR.

Multiple-valued calculation units are employed by the hardware security unit 1 according to the present invention, within which each of the functional entities can be considered as a multiple-valued logic calculation unit. The function corresponding to the multiple-valued logic calculation unit can be one of Owner, PCR, SRK, Key, private password and protected data.

When creating a multiple-valued logic calculation unit of the hardware security unit 1 according to the present invention, a key for a simple cryptography service can be provided in the case of UNKNOWN if a certain Key in use is of low security level. Therefore, the expected state of a multiple-valued logic calculation unit of Key is set as UNKNOWN at the time of Key creation.

It is also assumed that the result of the PCR measurement changes in this phase, causing the check result of the current state of the Key to change into UNKNOWN.

The first register of the multiple-valued logic calculation unit for “Owner” describes the expected logic state of “Owner” as T.

The second register of the multiple-valued logic calculation unit for “Owner” describes the current logic state of “Owner” as T.

The third register of the multiple-valued logic calculation unit for “Owner” describes the multiple-valued logic operator as null, i.e., no logic operator.

The first register of the multiple-valued logic calculation unit for “SRK” describes the expected logic state of “SRK” as T.

The second register of the multiple-valued logic calculation unit for “SRK” describes the current logic state of “SRK” as T.

The third register of the multiple-valued logic calculation unit for “SRK” describes the multiple-valued logic operator for “SRK” as AND, which indicates that the operational relationship between “Owner” and “SRK” is AND.

The first register of the multiple-valued logic calculation unit for “PCR” describes the expected logic state of “PCR” as T.

The second register of the multiple-valued logic calculation unit for “PCR” describes the current logic state of “PCR” as T.

The third register of the multiple-valued logic calculation unit for “PCR” describes the multiple-valued logic operator for “PCR” as AND, which indicates that the operational relationship between “SRK” and “PCR” is AND.

The first register of the multiple-valued logic calculation unit for “Key” describes the expected logic state of “Key” as U.

The second register of the multiple-valued logic calculation unit for “Key” describes the current logic state of “Key” as U.

The third register of the multiple-valued logic calculation unit for “Key” describes the multiple-valued logic operator for “Key” as AND, which indicates that the operational relationship between “PCR” and “Key” is AND.

In the following, the flow of the operation for the expected logic state by the operational unit 13 is described in detail together with the specific contents of the respective registers of the multiple-valued logic calculation units.

With the expected logical state of “Owner” being T, the expected logical state of “SRK” being T and the logic operation performed by the operational unit 13 being AND, the result is T.

The operational unit 13 performs a logic operation, which is specifically AND, between the result obtained from the operation between “Owner” and “SRK”, T, and the expected logical state of “PCR”, T, leading to a result of T again.

The operational unit 13 performs a logic operation, which is specifically AND, between the result obtained from the logic operation of “Owner” and “SRK” with “PCR”, T, and the expected logical state of “Key”, U, leading to a result of U. In other words, a state of unknown means available.

In the following, the flow of the operation for the current logic state by the operational unit 13 is described in detail together with the specific contents of the respective registers of the multiple-valued logic calculation units.

With the current logical state of “Owner” being T, the current logical state of “SRK” being T and the logic operation performed by the operational unit 13 being AND, the result is T.

The operational unit 13 performs a logic operation, which is specifically AND, between the result obtained from the operation between “Owner” and “SRK”, T, and the current logical state of “PCR”, T, leading to a result of T again.

The operational unit 13 performs a logic operation, which is specifically AND, between the result obtained from the logic operation of “Owner” and “SRK” with “PCR”, T, and the current logical state of “Key”, U, leading to a result of U. In other words, a state of unknown means available.

The judgment unit 14 compares the final result of the expected logical state, U, with the final result of the current logical state, U. As the hardware security unit according the present invention applies a judgment scheme of lowest limit to the comparison, the Key can provide services and the execution unit 15 can execute the command.

At the time of creating a multiple-valued logic calculation unit of the hardware security unit according to the present invention, a key for a simple cryptography service can be provided in the case of TRUE if a certain KeyA in use is of high security level. Therefore, the expected state of the KeyA's multiple-valued logic calculation unit is set as TRUE at the time of creating the KeyA.

It is also assumed that the result of the PCR measurement changes in this phase, causing the check result of the current state of the KeyA to change into UNKNOWN.

The first register of the multiple-valued logic calculation unit for “Owner” describes the expected logic state of “Owner” as T.

The second register of the multiple-valued logic calculation unit for “Owner” describes the current logic state of “Owner” as T.

The third register of the multiple-valued logic calculation unit for “Owner” describes the multiple-valued logic operator as null, i.e., no logic operator.

The first register of the multiple-valued logic calculation unit for “SRK” describes the expected logic state of “SRK” as T.

The second register of the multiple-valued logic calculation unit for “SRK” describes the current logic state of “SRK” as T.

The third register of the multiple-valued logic calculation unit for “SRK” describes the multiple-valued logic operator for “SRK” as AND, which indicates that the operational relationship between “Owner” and “SRK” is AND.

The first register of the multiple-valued logic calculation unit for “PCR” describes the expected logic state of “PCR” as T.

The second register of the multiple-valued logic calculation unit for “PCR” describes the current logic state of “PCR” as T.

The third register of the multiple-valued logic calculation unit for “PCR” describes the multiple-valued logic operator for “PCR” as AND, which indicates that the operational relationship between “SRK” and “PCR” as AND.

The first register of the multiple-valued logic calculation unit for “KeyA” describes the expected logic state of “KeyA” as T.

The second register of the multiple-valued logic calculation unit for “KeyA” describes the current logic state of “KeyA” as U.

The third register of the multiple-valued logic calculation unit for “KeyA” describes the multiple-valued logic operator for “KeyA” as AND, which indicates that the operational relationship between “PCR” and “KeyA” as AND.

In the following, the flow of the operation for the expected logic state by the operational unit 13 is described in detail together with the specific contents of the respective registers of the multiple-valued logic calculation units.

With the expected logical state of “Owner” being T, the expected logical state of “SRK” being T and the logic operation performed by the operational unit 13 being AND, the result is T.

The operational unit 13 performs a logic operation, which is specifically AND, between the result obtained from the operation between “Owner” and “SRK”, T, and the expected logical state of “PCR”, T, leading to a result of T again.

The operational unit 13 performs a logic operation, which is specifically AND, between the result obtained from the logic operation of “Owner” and “SRK” with “PCR”, T, and the expected logical state of “KeyA”, T, leading to a result of T. In other words, it is available when the logic operation result is TRUE.

In the following, the flow of the operation for the current logic state by the operational unit 13 is described in detail together with the specific contents of the respective registers of the multiple-valued logic calculation units.

With the current logical state of “Owner” being T, the current logical state of “SRK” being T and the logic operation performed by the operational unit 13 being AND, the result is T.

The operational unit 13 performs a logic operation, which is specifically AND, between the result obtained from the operation between “Owner” and “SRK”, T, and the current logical state of “PCR”, T, leading to a result of T again.

The operational unit 13 performs a logic operation, which is specifically AND, between the result obtained from the logic operation of “Owner” and “SRK” with “PCR”, T, and the current logical state of “KeyA”, U, leading to a result of U. In other words, a state of unknown means available.

The final result of the desired logical state, T, is compared with the final result of the current logical state, U. As the hardware security unit according the present invention applies a judgment scheme of lowest limit to the comparison, the KeyA cannot provide services and the command cannot be executed.

Depending on application requirements, the security levels of the expected logical state and the current logical state according to the present invention can be further subdivided. The triple-valued logic can be extended to a fourfold-valued logic, a fivefold-valued logic or higher multiple-valued logic. More logic operators can be introduced, and parallel logic branches can be taken into account. When a fourfold-valued logic, a fivefold-valued logic or higher multiple-valued logic is applied, specific logic values can be mapped to specific values before making comparisons and judgments.

The foregoing are only preferred embodiments and should not be considered as limiting the present invention. It will be understood by those skilled in the art that various changes, equivalent alternatives and modifications may be made without departing from the spirit and scope of the present invention defined by the appended claims.

What is claimed is:

1. A hardware security unit comprising at least a first multiple-valued logic calculation unit, a second multiple-valued logic calculation unit and an operational unit, the first multiple-valued logic calculation unit and the second multiple-valued logic calculation unit being connected to the operational unit, respectively,
each of the multiple-valued logic calculation units comprises at least three registers:
a first register for describing expected logical state of a specific entity of the hardware security unit,
a second register for describing current logical state of a specific entity of the hardware security unit, and
a third register for describing a multiple-valued logic operator between specific entities of the hardware security unit;
the operational unit is configured to apply calculation to the first expected logical state of the first multiple-valued logic calculation unit and the second expected logical state of the second multiple-valued logic calculation unit to obtain an expected logic operation result, and to apply calculation to the first current logical state of the first multiple-valued logic calculation unit and the second current logical state of the second multiple-valued logic calculation unit obtain a current logic operation result, by using the multiple-valued logic operator in the third register of the second multiple-valued logic calculation unit.

2. The hardware security unit according to claim 1, wherein the specific entities of the hardware security unit are any two of owner's password Owner, platform information PCR, storage root key SRK, key Key, private password and protected data.

3. The hardware security unit according to claim 1, further comprising a setting unit connected to at least one of the first and second multiple-valued logic calculation units, for setting the expected logical state and the multiple-valued logic operator of the connected multiple-valued logic calculation unit.

4. The hardware security unit according to claim 3, wherein the setting unit comprises a setting unit for user and a setting unit for hardware security unit, the setting unit for hardware security unit being used to preset the expected logical states and the multiple-valued logic operator for the Owner, the PCR and the SRK.

5. The hardware security unit according to claim 1, further comprising a checking unit connected to both of the first and second multiple-valued logic calculation units, for checking the first and second current logical states in the second registers of the first and second multiple-valued logic calculation units.

6. The hardware security unit according to claim 1, further comprising a maintenance unit connected to both of the first and second multiple-valued logic calculation units, for maintaining the first and second current logical states in the second registers of the first and second multiple-valued logic calculation units.

7. The hardware security unit according to claim 1, further comprising an updating unit connected to both of the first and second multiple-valued logic calculation units, for updating the first and second current logical states in the second registers of the first and second multiple-valued logic calculation units.

8. The hardware security unit according to claim 1, further comprising a counting unit connected to both of the first and second multiple-valued logic calculation units, for counting any used multiple-valued logic calculation units,
wherein the operational unit performs logic operations based on the multiple-valued logic operators in the third registers of the multiple-valued logic calculation units counted by the counting unit.

9. The hardware security unit according to claim 1, further comprising a judgment unit connected to the operational unit, for judging whether the current logic operation result has reached the expected logic operation result.

10. The hardware security unit according to claim 1, further comprising an execution unit connected to the judgment unit, for executing a corresponding operation based on the judgment result by the judgment unit.

11. A multiple-valued logic operational method for a hardware security unit comprising at least a first multiple-valued logic calculation unit, a second multiple-valued logic calculation unit and an operational unit,
the method comprises:
applying, by the operational unit, calculation to the first expected logical state of the first multiple-valued logic calculation unit and the second expected logical state of the second multiple-valued logic calculation unit to obtain an expected logic operation result, using the multiple-valued logic operator in the third register of the second multiple-valued logic calculation unit; and
applying, by the operational unit, calculation to the first current logical state of the first multiple-valued logic calculation unit and the second current logical state of the second multiple-valued logic calculation unit obtain a current logic operation result, using said multiple-valued logic operator.

12. The method according to claim 11, further comprising, before the step of applying calculation, a setting step of setting the expected logical state and the multiple-valued logic operator of at least one of the first and second multiple-valued logic calculation units in advance.

13. The method according to claim 11, further comprising, before the step of applying calculation, a counting step of counting any used multiple-valued logic calculation units, wherein the operational unit performs logic operations based on the multiple-valued logic operators of the multiple-valued logic calculation units counted by the counting unit.

14. The method according to claim 11, further comprising, after obtaining the expected and the current logic operation results, a judgment step of judging whether the current logic operation result has reached the expected logic operation result.

15. The method according to claim 14, further comprising, after the judgment step, an execution step of executing a corresponding operation based on the judgment result at the judgment step.
